(19) United States
(12) Patent Application Publication
(10) Pub. No.: US 2014/0364354 A1
(43) Pub. Date: Dec. 11, 2014

(54) WATER-BASED DETERGENT

(71) Applicant: IDEMITSU KOSAN CO., LTD, Chiyoda-ku, Tokyo (JP)

(72) Inventor: Hiroshi Kawasaki, Ichihara-shi (JP)

(73) Assignee: IDEMITSU KOSAN CO., LTD, Chiyoda-ku, Tokyo (JP)

(21) Appl. No.: 14/366,435

(22) PCT Filed: Dec. 26, 2012
(86) PCT No.: PCT/JP2012/083543

§ 371 Date: Jun. 18, 2014

(30) Foreign Application Priority Data
Dec. 27, 2011 (JP) 2011-286332

(51) Int. Cl. C11D 3/36; C11D 3/20; C11D 3/30

(52) U.S. Cl. CPC C11D 3/362; C11D 3/30; C11D 3/2075
USPC 510/467

(57) ABSTRACT

An aqueous detergent contains: (A) a branched carboxylic acid having 9 to 11 carbon atoms; (B) alkanolamine; and (C) at least one of phosphate represented by a formula [1] below or a salt of the phosphate,

{RO(CH₂CH₂O)ₙ}ₘ—P═O(OH)₃₋ₘ [1]

in which, R is an alkyl group having 6 to 30 carbon atoms, n is an integer of 4 to 20, and m is an integer of 1 to 3.

### TECHNICAL FIELD

The present invention relates to an aqueous detergent used for washing machine components and the like.

### BACKGROUND ART

Metalworking fluid used in metalworking and subsequent washing is generally categorized into oil-based fluid and water-based fluid, the latter of which is more frequently used because such water-based fluid is excellent in cooling capabilities and infiltration capabilities and free from a risk of causing a fire. In general, the stock solution of water-based cutting oil, grinding oil or washing oil is diluted with water to a ratio from 1:1 to 1:200 in use.

In the manufacturing process of automobiles or machine components, when the automobiles or machine components are washed with emulsion-type aqueous machining oil in a previous process, cut powders and surface stickiness cannot he removed by simply drying the automobile or machine components without applying any treatment. Thus, no-rinse washing is often applied in the subsequent processes using solution-type aqueous washing oil (aqueous detergent). The rinsing is omitted in order to reduce the disposal amount of waste fluid.

For instance, in order to degrease metal, ceramics and the like, an aqueous detergent containing a polyalkylene glycol and non-ionic surface-active agent has been proposed (see Patent Literature 1). Further, a water-soluble detergent for aluminum that contains alkanolamine salt having 8 to 12 carbon atoms and sodium silicate (or potassium) and has pH of 7 to 10 has been proposed (see Patent Literature 2).

### CITATION LIST

### Patent Literatures

Patent Literature 1: JP-A-2000-336391

Patent Literature 2: Japanese Patent No. 3081452

### SUMMARY OF THE INVENTION

### Problems to be Solved by the Invention

The above-described solution-type aqueous washing oil (aqueous detergent) is usually practically satisfactory in terms of detergency performance in the sense of removing residual aqueous machining oil from an object to be washed. However, rust-inhibiting effect and hard-water stability at a lower concentration (secondary characteristics common to the aqueous machining oil) tend to be required. Especially, when soap scum (scum) is deposited on the surface of the object to be washed due to hard components (e.g. Ca and Mg) in the diluted water, water is adsorbed thereto, resulting in generation of rust and the like. However, the aqueous detergent disclosed in Patent Literature 1 does not necessarily satisfy both of rust-inhibiting effect and hard-water stability.

Further, when an aqueous detergent is intended to wash an object containing, aluminum or a component made of an aluminum alloy, the aqueous detergent needs to be formulated not to cause corrosion or discoloration of the washed object. The water-soluble detergent for aluminum disclosed in Patent Literature 2 exhibits a good discoloration-inhibiting effect on aluminum but is poor in hard-water stability. In other words, this water-soluble detergent is likely to become cloudy due to water-insoluble substances derived from various mineral components in the stock solution of the detergent. Further, this water-soluble detergent is so alkaline that blending a large amount of this detergent may result in acceleration of aluminum corrosion. Still further, an aqueous detergent is required to exhibit a defoaming property.

In view of the above, an object of the invention is to provide an aqueous detergent capable of preventing discoloration of aluminum without deteriorating rust-inhibiting effect, defoaming property and hard-water stability.

### Means for Solving the Problems

In order to solve the above problem(s), the invention provides the following aqueous detergent.

(1) According to an aspect of the invention, an aqueous detergent contains: (A) a branched carboxylic acid having 9 to 11 carbon atoms; (B) alkanolamine: and (C) at least one of phosphate represented by a formula [1] below or a salt of the phosphate,

{RO(CH₂CH₂O)ₙ}ₘ—P═O(OH)₃₋ₘ [1]

in which, R is an alkyl group having 6 to 30 carbon atoms, n is an integer of 4 to 20, and m is an integer of 1 to 3.

(2) In the aqueous detergent, a blending amount of the component (A) and the component (B) is 70 mass % or less of the detergent.

(3) in the aqueous detergent, a blending amount of the component (C) is 0.05 to 5 mass % of the detergent.

(4) An aqueous detergent is prepared by diluting the above aqueous detergent with water at a ratio of 1:200 or less.

According to the above aspect of the invention, it is possible to provide an aqueous detergent that is capable of preventing discoloration of a newly formed surface of aluminum or aluminum alloy subjected to metalworking and is excellent in rust-inhibiting effect, defoaming property and hard-water stability.

### EXEMPLARY EMBODIMENT

An aqueous detergent according to an exemplary embodiment of the invention (hereinafter, occasionally referred to simply as “the present detergent”) is prepared by blending: (A) a branched carboxylic acid having 9 to 11 carbon atoms; (B) alkanolamine: and (C) at least one of phosphate represented by the following formula [1] and a salt of the phosphate.

{RO(CH₂CH₂O)ₙ}ₘ—P=PO(OH)₃₋ₘ [1]

In the formula, R is an alkyl group having 6 to 30 carbon atoms, n is an integer of 4 to 20, and m is an integer of 1 to 3.

The present detergent will be described below in detail.

### Component (A)

The component (A) of the present detergent is a branched carboxylic acid having 9 to 11 carbon atoms. The branched carboxylic acid is exemplified by an aliphatic monobasic acid or an aliphatic dibasic acid.

Examples of the aliphatic monobasic acid include 3,5,5-trimethylhexanoic acid, cyclohexyl-propionic acid, neodecanoic acid, 2-ethyl-2,3,3-trimethylbutanoic acid, 2-isopropyl-2,3-dimethylbutanoic acid, 2,2,3,3-tetramethylpentanoic acid, 2,2,3,4-tetramethylpentanoic acid, and 2,2,4,4-tetramethylpentanoic acid.

An aliphatic monobasic acid with a carbon number that falls outside the above range or an aliphatic monobasic acid having a linear alkyl group does not favorably exhibit the advantages of the invention. Especially, when the carbon number is 8 or less, the aliphatic monobasic acid is not preferable in terms of rust-inhibiting effect and smell. Further, a carboxylic acid having 12 or more carbon atoms is not preferable due to the poor hard-water stability thereof, either. Still further, a carboxylic acid having a linear alkyl group is not preferable due to the poor hard-water stability thereof, either.

### Component (B)

The component (B) of the present detergent is alkanolamine. The alkanolamine is subject to no particular limitation but primary alkanolamine and tertiary alkanolamine are preferably usable. Primary alkanolamine highly contributes to improvement in decay resistance. Tertiary alkanolamine is excellent in improving rust-inhibiting effect and further in maintaining the improved rust-inhibiting effect.

Examples of the primary alkanolamine include monoisopropanolamine, 2-amino-2-methyl-1-propanol, monoethanolamine, mono-n-propanolamine, N-(β-aminoethyl)ethanolamine and N-(β-aminoethyl)isopropanolamine. Examples of the tertiary alkanolamine include triethanolamine, cyclohexyldiethanolamine, monoethanoldiisopropanolamine, tri(n-propanol)amine, triisopropanolamine, N,N-dimethylethanolamine, N,N-diethylethanolamine, N,N-dibutylethanolamine, N-methyldiethanolamine, N-ethyldiethanolamine, N-n-butyldiethanolamine, N-t-butyldiethanolamine and N,N-diethylisopropanolamine. Among the above, preferable examples of the primary alkanolamine are monoisopropanolamine and 2-amino-2-methyl-1-propanol, and preferable examples of the tertiary alkanolamine are monoethanoldiisopropanolamine, triethanolamine, triisopropanolamine, N-methyldiethanolamine and cyclohexyldiethanolamine.

The blending amount of the primary alkanolamine and the tertiary alkanolamine (mol ratio: primary alkanolamine/tertiary alkanolamine) is preferably 10 or less, more preferably 3 or less, further more preferably 1 or less.

A blending ratio (mass ratio) of the component (A) and the component (B) is preferably in a range from 1:1 to 1:20 ((A):(B)). The component (A) becomes water-soluble when the component (A) generates salt in combination with the component (B). However, when the amount of the component (B) is less than one parts for one part of the component (A), it is likely that the component (A) fails to become water-soluble or scum properties become poor, so that the resulting aqueous solution may be unfavorable to use as a clear aqueous solution. On the other hand, when the amount of the component (B) exceeds 20 parts for one part of the component (A), rust-inhibiting effect may be lowered. In view of the above, the blending ratio (A):(B) is preferably in a range from 1:2 to 1:8.

### Component (C)

The component (C) of the present detergent is phosphate represented by the following formula [1] or a salt thereof.

{RO(CH₂CH₂O)ₙ}ₘ—P═O,(OH)₃₋ₘ [1]

In the formula [1], R represents an alkyl group having 6 to 30 carbon atoms, preferably 8 to 20 carbon atoms. When the carbon number of R is 5 or less, hard-water stability becomes poor when the stock solution of the detergent is diluted with water. On the other hand, when the carbon number of R is 31 or more, solubility to the stock solution of the detergent may be lowered. In the formula [1], n is an integer of 4 to 20, preferably an integer of 4 to 15. When n is 3 or less, hard-water stability becomes poor when the stock solution of the detergent is diluted with water. On the other hand, when n is 21 or more, a molecular weight is 1000 or more and thus discoloration-inhibiting effect on aluminum is lowered. In the formula [1], m is an integer of 1 to 3. More specifically, m is preferably 1 or 2 in terms of improvement of water-solubility. Incidentally, when m is 2 or 3, plural R may be mutually the same or different and likewise plural n may be mutually the same or different.

When the phosphate is monoester or diester, the component (C) may be a salt. Examples of the salt include an alkali metal salt or an amine salt. Examples of the alkali metal salt include sodium salt and potassium salt.

### The Present Detergent

The aqueous detergent according to the exemplary embodiment is prepared by blending the components (A), (13) and (C) and dissolving the mixture in a solvent (e.g., water). In view of handleability, it is preferable that a high-concentration stock solution of the present detergent is initially prepared. In this case, the blending amount (total) of the components (A) and (B) is preferably 70 mass % or less of the stock solution. more preferably 50 mass % or less of the stock solution. When the concentration exceeds 70 mass %, the detergent components may not be easily dissolved in water when preparing the stock solution. Incidentally, in terms of the advantages of the invention, the concentration is preferably 10 mass % or more.

The stock solution is directly usable as a detergent, but is usually diluted with water by a user as needed (e.g., a dilution ratio of approximately 1:200 or less) to be used as an aqueous detergent. When the dilution ratio exceeds 1:200, the advantages of the invention may be insufficiently enjoyed. Incidentally, the water to be used may be either hard water or soft water. Thus, the water to be used may be tap water, industrial water ion-exchange water, distilled water and the like as desired.

The concentration of the component (C) in the stock solution is preferably in a range from 0.05 to 5 mass % of the stock solution in terms of discoloration-inhibiting effect on aluminum. The concentration of the component (C) in the diluted stock solution is preferably in a range from 2 mass ppm to 5 mass % in view of the advantages of the invention.

When the present detergent diluted with water is used for aluminum or aluminum alloy, the pH of the present detergent is preferably 10 or less, more preferably 9.5 or less so that the present detergent exhibits a favorable corrosion resistance, prevents discoloration of a newly formed surface and is excellent in rust-inhibiting effect and defoaming property. Incidentally, the present detergent is preferably alkalescent in view of decay resistance and rust-inhibiting effect on iron and thus the pH is preferably 7 or more, more preferably 7.5 or more.

The pH can be adjusted by changing the ratio of the component (B).

The present detergent is especially used for aluminum or aluminum alloy. Examples of the aluminum alloy include Al—Si alloys, Al—Mn—(Mg) alloys, Al—Mg alloys. Al—Cu alloys, Al—Cu—Mg alloys, Al—Mg—Si alloys, Al—Zn—Mg—(Cu) alloys and Al—Li alloys

The present detergent is capable of preventing discoloration of, especially, a newly formed surface of aluminum or aluminum alloy subjected to metalworking and is excellent in rust-inhibiting effect, defoaming property and hard-water stability.

### Others (Additives)

The present detergent may be blended as necessary with publicly known various kinds of additives as long as an object of the invention is not hampered. Examples of the additives include water-soluble anticorrosive agent, defoaming agent and bactericide.

Examples of the water-soluble anticorrosive agent include: triazoles such as benzotriazole, methyl benzotriazole, tolyltriazole and hydrocarbyl triazole, and salt thereof: sodium salt or potassium salt of an inorganic acid such as boric acid, tungsten acid, molybdenum acid, phosphoric acid, sulfuric acid, silicic acid, nitric acid and nitrous acid; thiazoles such as mercapto-benzothiazole, and salt thereof; aliphatic alkanolamides; imidazolines; and oxazolines.

Examples of the defoaming agent include methyl silicone oil, fluorosilicone oil and polyacrylate.

Preferable examples of the bactericide include isothiazoline compound, salicylanilide compound and 2-pyridylthio-1-oxide salt. Examples of the 2-pyridylthio-1-oxide salt include 2-pyridylthio-1-oxide sodium, bis(2-pyridylthio-1-oxide)zinc and bis(2-sulfidepyridine-1-olato) copper. Among the above, 2-pyridylthio-1-oxide sodium is particularly preferable because this compound is effective on general bacteria and molds in a wide range even when contained at a low concentration. Further, it is particularly preferable that this compound is used in combination with an isothiazoline compound.

The total blending amount of the above various additives is preferably 3 mass % or less of the total amount of the composition (stock solution).

### EXAMPLES

Next, the exemplary embodiment of the invention will be described in detail with reference to Examples. However, the invention is not limited at all by Examples.

### Examples 1 to 5 and Comparative Examples 1 to 21

Table 1 shows a composition of a stock solution. Table 2 shows the details of “Component (C), etc.” in Table 1. Incidentally, polyoxyethylene alkyl ether phosphate (salt) used in Examples 1 to 5 are included in the component (C) according to the exemplary embodiment of the invention.

A sample solution was prepared by diluting the stock solution according to Table 1 with water at a predetermined ratio and was evaluated in terms of defoaming property, discoloration of aluminum and hard-water stability. Results are shown in Table 2. Details of the evaluation methods are as follows.

TABLE 1

| | Blending Amount |
|---|---|
| Ingredients | (mass %) |
| isononanoic acid | 5.87 |
| monoethanoldiisopropanolamine | 22.55 |
| benzotriazole | 0.50 |
| ion-exchange water | 69.98 |
| bactericide | 0.40 |
| (isothiazoline-based + pyridine-based) | |
| silicone defoaming agent | 0.20 |
| Component (C), etc. | 0.50 |
| Total | 100.00 |

### Evaluation Method of Defoaming Property

The defoaming property was evaluated according to a cylinder method. Specifically, 95 mL of ion-exchange water was put into a 100-mL-stoppered measuring cylinder and was added with 5 mL of the stock solution. The cylinder was then vigorouslv shaken. Time counting was started when the cylinder was put on a fiat place. A time when bubbles on the surface disappeared to a level where a half or more of an air-liquid interface (area) became visible was checked. When bubbles disappeared after the elapse of n seconds less than 30 seconds, n-0 was recorded.

Other Recording Method

When bubbles did not disappear in 30 seconds, the amount of the bubbles remaining alter the elapse of 30 seconds was recorded.

Examples of Record

5 mL of bubbles remained after the elapse of 30 seconds: 30-5

30 mL or more of bubbles remained after the elapse of 30 seconds: 30-30≦

### Evaluation Method of Discoloration of Aluminum (Immersion Test)

The following two test pieces were prepared.

JIS A6061 (aluminum alloy): 72×25×1 mm

JIS ADC12 (aluminum alloy): 81×19×11 mm

Next, both surfaces of each of the test pieces were uniformly polished with a strip of sandpaper (C320) and powder of the test piece was wiped off after the polishing. Subsequently, the thus-polished test pieces were put in a beaker, into which acetone was poured until the test pieces were immersed, and washed for 10 minutes using an ultrasonic cleaner (manufactured by ASONE Corporation, model: “USD-2R”). The washed test pieces were put in a single layer in a basket to be dried.

Next, a sample solution prepared by twentyfold diluting the stock solution with ion-exchange water (i.e., 5%-diluted solution) was poured into a 100-mL lidded sample bottle and a test detergent was poured thereinto until the polished test pieces were entirely immersed in the detergent. After the lid was closed, the sample bottle was left still in a constant-temperature bath of 60 degrees C. for two hours. Then, the test pieces taken out of the bottle were washed with tap water and dried by wiping moisture off.

The thus-treated test pieces were each evaluated in discoloration of aluminum (discoloration-inhibiting effect) in accordance with the following criteria by visually examining the discoloration of the appearance thereof.

A: no discoloration of the immersed surface

B: less than 50% of the immersed surface discolored

B: 50% or more of the immersed surface discolored

D: the immersed surface entirely blackened

Incidentally, the evaluation results of the discoloration of A6061 and the discoloration of ADC12 were shown side by side (e.g., AA and DD). Further. the appearance of the solution was also visually examined after the immersion test to check for the presence/absence of white turbidity and precipitation

### Evaluation Method of Hard-Water Stability

70 ml, of ion-exchange water, 20 mL of Ca hard water (hardness 5000, CaCl₂ 5.54 g/L), and 5 mL of the stock solution were poured into a 100-mL-stoppered measuring cylinder and ion-exchange water was further added therein to provide 100 mL constant volume. The cylinder was then well shaken. After the cylinder was left still at room temperature for 24 hours, the presence/absence of the deposition (precipitation) of calcium salt (scum) was recorded. When the solution was clear without precipitation, a rating of A was given.

TABLE 2

| | | | | Defoaming | | | |
|---|---|---|---|---|---|---|---|
| | | | | Property | | | Hard-Water Stability |
| | Ingredients (Component (C), etc.) | | | (Cylinder | Discoloration of | Appearance | 5%-diluted Solution |
| | | Manufacturer (trade name) | | Method) | Aluminum | of Solution | (Hardness 1000) |
| Ex. 1 | polyoxyethylene(6)alkyl(C12-15)ether phosphate | TOHO Chemical Industry Co., Ltd. | PHOSPHANOL RS-610 | 13-0 | AA | Good | A |
| Ex. 2 | polyoxyethylene(9)alkyl(C12-15)ether phosphate | TOHO Chemical Industry Co., Ltd. | PHOSPHANOL RS-710 | 17-0 | AA | Good | A |
| Ex. 3 | polyoxyethylene(4)oleyl ether phosphate | TOHO Chemical Industry Co., Ltd. | PHOSPHANOL RB-410 | 8-0 | AA | Good | A |
| Ex. 4 | polyoxyethylene(4)lauryl ether sodium phosphate | TOHO Chemical Industry Co., Ltd. | PHOSPHANOL 702 | 8-0 | AA | Good | A |
| Ex. 5 | polyoxyethylene lauryl ether potassium phosphate | Kao Corporation | ELECTROSTRIPPER F | 7-0 | AA | Good | A |
| Comp. 1 | — | — | | 8-0 | DD | Good | |
| Comp. 2 | organophosphate, triethanolamine 1-10% | CHELEST CORPORATION | Cheleslight AL-3 | 9-0 | CD | Good | |
| Comp. 3 | amine phosphate | CHELEST CORPORATION | Cheleslight AL-5 | 10-0 | AA | Good | Deposition |
| | | | | | | | Occurred |
| Comp. 4 | sodium metaphosphate (NaPO₃)n | — | | 9-0 | BB | Good | Deposition |
| | | | | | | | Occurred |
| Comp. 5 | sodium tripolyphosphate (Na₅P₃O₁₀) | — | | 9-0 | BB | Good | Deposition |
| | | | | | | | Occurred |
| Comp. 6 | sodium polyphosphate | — | | 9-0 | AA | Good | Deposition |
| | | | | | | | Occurred |
| Comp. 7 | disodium hydrogen phosphate + sodium dihydrogen phosphate | CHELEST CORPORATION | Cheleslight AL-52 | 9-0 | BC | Good | Deposition |
| | | | | | | | Occurred |
| Comp. 8 | tetrasodium hydroxyethylidene diphosphonate 25-29% | CHELEST CORPORATION | Chelest PH-214 | 9-0 | AA | Good | Deposition |
| | | | | | | | Occurred |
| Comp. 9 | nitrilotris(pentasodium methylene phosphonate) 38-40% | CHELEST CORPORATION | Chelest P11-325 | 9-0 | AA | Good | Deposition |
| | | | | | | | Occurred |
| Comp. 10 | sodium lauryl phosphate | Nikko Chemicals Co., Ltd. | NIKKOL SLP-N | 3-0 | AA | Cloudy | |
| Comp. 11 | polyoxyethylene(2)lauryl ether phosphate | TOHO Chemical Industry Co., Ltd | PHOSPHANOL ML-220 | 10-0 | AA | Good | Deposition |
| | | | | | | | Occurred |
| Comp. 12 | polyoxyethylene(3)alkyl(C12-15)ether phosphate | TOHO Chemical Industry Co., Ltd | PHOSPHANOL RS-410 | 11-0 | AA | Good | Deposition |
| | | | | | | | Occurred |
| Comp. 13 | sodium dodecyl diphenyl ether disulfonate | Kao Corporation | PELEX SS-L | 14-0 | CD | Good | |
| Comp. 14 | sodium dodecyl benzene sulfonate | Kao Corporation | NEO PELEX No. 6 | 30-30< | DD | Good | |
| Comp. 15 | sodium di-2-ethylhexyl sulfosuccinate | Nikko Chemicals Co., Ltd. | NIKKOL OTP-100 | 30-15 | DD | Good | |
| Comp. 16 | sodium [symbol] sulfate | Nikko Chemicals Co., Ltd. | NIKKOL [symbol] | 30-25 | DD | Good | |
| Comp. 17 | sodium [symbol] | Nikko Chemicals Co., Ltd. | NIKKOL S [symbol] S | 2-0 | DD | Good | |
| Comp [symbol] 18 | sodium [symbol] | Nikko Chemicals Co., Ltd. | NIKKOL [symbol] | 30-20 | DD | Good | |
| Comp. 19 | sodium m [symbol] (Na₂SiO [symbol] 9H₂O) | — | | 9-0 | AA | Deposition | A |
| Comp [symbol] 20 | sodium p [symbol] te | NIPPON SHOK [symbol] LTD | AQ [symbol] | [symbol] -0 | CD | Good | |
| Comp. 21 | [symbol] | NIPPON SHOK [symbol] LTD | AQ [symbol] | 9-0 | DD | Good | |

[symbol]

indicates data missing or illegible when filed

### Evaluation Results

The results in Table 2 show that the detergents of Examples 1 to 5 are capable of preventing discoloration of aluminum while maintaining favorable defoaming property and hard-water stability. In particular, discoloration of aluminum can be prevented irrespective of the use of warm water (60 degrees C.). In contrast, the detergents of Comparative Examples 1 to 21 cannot exhibit the above properties with balance for lack of the essential detergent components according to the exemplary embodiment of the invention.

### Examples 6 and 7 and Comparative Examples 22 and 23

Example 6 and Comparative Example 22 in Table 3 show a composition (stock solution) intended for a detergent dedicated for iron and aluminum. Example 7 and Comparative Example 23 in Table 3 shows a composition (stock solution) intended for a detergent dedicated for aluminum. These stock solutions were diluted with water for evaluation. Specifically, in addition to the above-described defoaming property and discoloration of aluminum, hard-water stability (Ca-inhibited hardness) and rust-inhibiting effect were evaluated in terms of practical use according to the following processes. Results are shown in Table 3.

### Ca-Inhibited Hardness

Hardness was increased in increments of 100 up to a maximum of 1000 and hard-water stability was evaluated every increment, thereby finding the maximum hardness at which no calcium salt (scum) precipitates. Specifically, the evaluation was made as follows.

According to the above-described processes of the evaluation method of hard-water stability, an additive amount of Ca hard water (hardness 5000, CaCl₂ 5.54 g/L) was gradually increased from 2 mL (hardness 100), 4 mL (hardness 200), 6 mL (hardness 300) . . . up to 20 mL (hardness 1000) and the evaluation of hard-water stability was repeated for up to a maximum of 10 times. When the hardness was increased to a level where it was difficult to determine the presence/absence of deposition of calcium salt (scum), the determination of the presence/absence was made after the solution was kept still for 24 hours or more. A practically required level of hard-water stability was set at a Ca-inhibited hardness of 300 or more.

### Evaluation Method of Rust-Inhibiting Effect

A rust resistance test (casting-cut-powder test) was performed in accordance with DIN51360-02A. Specifically, the test was performed as follows.

On a 70-mm-diameter sheet of filter paper (No. 5C) on a petri dish, 2 g of casting-cut-powder (i.e., casting-cut-powder prepared by dry-cutting FC-250) was put without powder particles being overlapped and was immersed in 2 mL of a diluted solution to be evaluated (i.e., a solution diluted with tap water). The petri dish was then covered. After the petri dish was left still at room temperature for two hours, the presence/absence of rust transferred on the filter paper was judged in accordance with five rusting levels (0, 1, 2, 3 and 4). The casting-cut-powder test was performed for each concentration of the diluted solution to be evaluated in light of the fact that the rusting level should become worse with a lower concentration of the diluted solution and become more favorable with a higher concentration. Specifically, the above test was performed for each concentration of the diluted solution and a minimum concentration where there was no rust (rusting level=0) was defined as a rust-inhibiting threshold (mass %), which was used as a reference for judging the rust-inhibiting effect on a sample. In other words, when the stock solution was diluted with ion-exchange water, the rust-inhibiting threshold was expressed by a proportion of the stock solution to the diluted solution.

TABLE 3

| | | Ex. 6 | Ex. 7 | Comp. 22 | Comp. 23 |
|---|---|---|---|---|---|
| | | iron & aluminum | aluminum | iron & aluminum | aluminum |
| Composition | sebacic acid | 1.24 | — | 1.24 | — |
| of | dodecanedioic acid | 0.94 | — | 0.94 | — |
| Stock | benzotriazole | 0.50 | 0.50 | 0.50 | 0.50 |
| Solution | isononanoic acid | — | 7.33 | — | 7.33 |
| (mass %) | neodecanoic acid | 4.28 | — | 4.28 | — |
| | N-methylethanolamine | 17.57 | 13.92 | 17.57 | 13.92 |
| | cyclohexyldiethanolamine | 5.15 | — | 5.15 | — |
| | monoisopropanolamine | 2.56 | — | 2.56 | — |
| | 85% triisopropanolamine | — | 8.76 | — | 8.76 |
| | polyoxyethylene(6)alkyl(C12-15)ether | 0.20 | — | — | — |
| | phosphate | | | | |
| | polyoxyethylene(4)oleyl ether phosphate | — | 0.20 | — | — |
| | tap water | 66.96 | 68.69 | 67.16 | 68.89 |
| | isothiazoline bactericide | 0.20 | 0.20 | 0.20 | 0.20 |
| | pyridine bactericide | 0.20 | 0.20 | 0.20 | 0.20 |
| | silicone defoaming agent | 0.20 | 0.20 | 0.20 | 0.20 |
| | Total | 100.00 | 100.00 | 100.00 | 100.00 |
| Evaluation | pH (3.3% aq) | 9.5 | 8.9 | 9.5 | 8.9 |
| Results | Ca-inhibited Hardness (5% aq) | 700 | 1000< | 700 | 1000< |
| | Room Temperature × 24 h or more | | | | |
| | Anti-rust Threshold (mass %) | 1.9 | 3.0 | 1.8 | 2.9 |
| | Discoloration of Aluminum | AA | AA | CD | DD |
| | Defoaming Property | 8-0 | 9-0 | 8-0 | 9-0 |

### Evaluation Results

The results in Table 3 show that the detergents of Examples 6 and 7 exhibit an excellent discoloration-inhibiting effect on aluminum even when warm water (60 degrees C.) is used while maintaining rust-inhibiting effect and defoaming property on iron. Therefore, it can be understood that the detergent according to the exemplary embodiment of the invention is excellent in terms of practical utility. In contrast, the detergents of Comparative Examples 22 and 23 exhibit favorable rust-inhibiting effect and defoaming property but the discoloration-inhibiting effect thereof to aluminum is poor for lack of the essential detergent components according to the exemplary embodiment of the invention.

1. A detergent comprising:
(A) a branched carboxylic acid having 9 to 11 carbon atoms;
(B) an alkanolamine; and
(C) at least one of phosphate represented by formula (1):
{RO(CH₂CH₂O)ₙ}ₘ—P═O(OH)₃₋ₘ (1)
or a salt thereof where R is an alkyl group having 6 to 30 carbon atoms; n is an integer from 4 to 20; and m is an integer from 1 to 3.

2. An aqueous detergent concentrate comprising water, and the detergent according to claim 1 wherein the combined mass of component (A) and component (B) of said detergent comprises 70% by mass or less of the aqueous detergent concentrate.

3. An aqueous detergent concentrate comprising water and the detergent according to claim 1, wherein component (C) of said detergent comprises 0.05 to 5% by mass of the aqueous detergent concentrate.

4. An aqueous detergent solution comprising water and the aqueous detergent concentrate according to claim 2 wherein the ratio between the water and concentrate is 1:200 or less.

5. An aqueous detergent solution comprising water and the aqueous detergent concentrate according to claim 3 wherein the ratio between the water and concentrate is 1:200 or less.

6. An aqueous detergent concentrate comprising water and the detergent according to claim 1 wherein the combined mass of component (A) and component (B) of said detergent comprises 50% by mass or less of the aqueous detergent concentrate.

7. The detergent according to claim 1, wherein the R in formula (1) is an alkyl group having 6 to 20 carbons.

8. The detergent according to claim 1, where the n in formula (1) is an integer from 4 to 15.

9. The detergent according to claim 1, where the m in formula (1) is either 1 or 2.

10. The aqueous detergent concentrate according to claim 2 wherein component (C) of said detergent comprises 0.05 to 5% by mass of the aqueous detergent concentrate.

11. The aqueous detergent concentrate according to claim 6 wherein component (C) of said detergent comprises 0.05 to 5% by mass of the aqueous detergent concentrate.
